(19) United States
(12) Patent Application Publication
(10) Pub. No.: US 2015/0114470 A1
(43) Pub. Date: Apr. 30, 2015

(54) FLOW CONTROL DEVICE AND THE METHOD FOR CONTROLLING THE FLOW THEREOF

(71) Applicant: National Chiao Tung University, Hsinchu City (TW)

(72) Inventors: Wei-Hua CHIENG, Hsinchu City (TW); Yi CHANG, Hsinchu City (TW); Shyr-Long JENG, Hsinchu County (TW); Chia-Chuan WANG, Taoyuan County (TW); Ching-Wei SHIH, Hsinchu City (TW); Bin-Han LUE, Taoyuan County (TW); Hsiang-Pin LU, Taoyuan County (TW)

(73) Assignee: National Chiao Tung University, Hsinchu City (TW)

(21) Appl. No.: 14/271,674

(22) Filed: May 7, 2014

(30) Foreign Application Priority Data
Oct. 31, 2013 (TW) 102139573

(51) Int. Cl. F16K 1/38; F16K 25/00

(52) U.S. Cl. CPC F16K 1/385; F16K 25/005
USPC 137/1; 137/219

(57) ABSTRACT

The flow control device is provided and the method for controlling the flow. A flow control device comprises: a body including a first end, opposite second end, a first flow channel and a second flow channel, a plug and a laminar flow layer accommodated in the second flow channel; a telescopic device accommodated the length of the telescopic device is adjustable, so as to control the flow of fluid flowing through the opening area in the body.

### BACKGROUND OF THE INVENTION

1. Field of the Invention

The present invention relates to a flow control device, more particularly to a flow control device and the method for controlling the fluid speed in the flow channel.

2. Description of the Prior Art

Please refer to FIG. 1, which illustrates the diagram of the thermal mass flow control device. The thermal mass flow control device 100 comprises a hollow body 110, an upstream 130 and a downstream 132. The fluid 140 flows from the upstream 130 to the downstream 132. A first temperature detector 150 is installed at the upstream 130. A second temperature detector 152 is installed at the downstream 132. A heater 154 is installed at the center of fluid 140. The heater 154 heats the fluid 140. When the fluid (such as gas) passes through, it is heated by the heater 154, and the temperature of gas will be increased. The first temperature detector 150 detects the first temperature T1. The second temperature detector 152 detects the second temperature T2. Thus, the temperature difference between the upstream and the downstream is ΔT, and the fluid flow data can be obtained from this temperature difference ΔT.

Regarding the abovementioned thermal mass flow detection method, the basic condition is that the gas must be maintained at laminar flow to obtain the correct data. Thus, the design of flow channel will be an important topic. At present, there are two design ways, one is to detect large flow in the flow channel, and the other is to measure small flow (milliliter grade) in the flow channel, in which the flow detector is placed in the flow channel.

Because the flow range applied in the flow control device has large variation, the flow control device adopting different gas flow needs different flow channel design. Thus, the production cost will be very high.

The present invention develops the flow channel design of flow control device used in vacuum equipment or epitaxy equipment. The prior art needs different flow channel for the flow control device with different flow. Thus, it will be very difficult for the user to select the flow control device and prepare the follow-up materials. The purpose of the present invention is to design a new flow channel. The flow control device adopting this flow channel design can be used in wide range of flow without changing the flow channel.

### SUMMARY OF THE INVENTION

Thus, the purpose of the present invention is to provide a flow control device for adjusting flow channel with respect to different flow.

The present invention provides a flow control device for controlling the flow. A flow control device comprises: a body including a first end, opposite second end, a first flow channel and a second flow channel, the first flow channel with a first pipe diameter, the second flow channel with a second pipe diameter, the second pipe diameter is greater than the first pipe diameter, the first flow channel punching through the first end to form first opening, the second flow channel punching through the second end to form second opening, the first flow channel connecting with the second flow channel via third opening; a plug accommodated in the second flow channel; a laminar flow layer accommodated in the second flow channel and fixing on the inside wall of the second flow channel; and a telescopic device accommodated in the body and connecting between laminar flow layer and plug, the length of the telescopic device is adjustable; wherein, the telescopic device is used to control the relative motion of plug in the body, to adjust the relative position of the plug and the third opening, in order to control the opening area of the third opening, so as to control the flow of fluid flowing through the opening area in the body.

The first end is the gas inlet, and the second end is the gas outlet.

The cross-sectional shape of the first flow channel is a circle.

The cross-sectional shape of the first flow channel includes the trapezoid, rhombus, triangle or ellipse.

The cross-sectional shape of the second flow channel is a circle.

The cross-sectional shape of the second flow channel includes the trapezoid, rhombus, triangle or ellipse.

The cross-sectional shape of the plug is a circle, trapezoid, rhombus, triangle or ellipse.

The material of the plug is rubber or stainless steel.

The telescopic device is solenoid valve, pneumatic valve, spring or hydraulic valve.

Another purpose of the present invention is to provide a flow control method for a flow control device. The method comprises: providing a body including a first end, opposite second end, a first flow channel and a second flow channel, the first flow channel with a first pipe diameter, the second flow channel with a second pipe diameter, the second pipe diameter is greater than the first pipe diameter, the first flow channel punching through the first end to form first opening, the second flow channel punching through the second end to form second opening, the first flow channel connecting with the second flow channel via third opening; providing a plug accommodated in the second flow channel; providing a laminar flow layer accommodated in the second flow channel and fixing on the inside wall of the second flow channel; and providing a telescopic device accommodated in the body and connecting between laminar flow layer and plug, the length of the telescopic device is adjustable; in which the telescopic device is used to control the relative motion of plug in the body, to adjust the relative position of the plug and the third opening, in order to control the opening area of the third opening, so as to control the flow of fluid flowing through the opening area in the body.

The function of the present invention is to suitably adjust large flow and small flow of fluid in wide range of flow without changing the flow channel.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the cross-sectional view of the thermal mass flow control device;

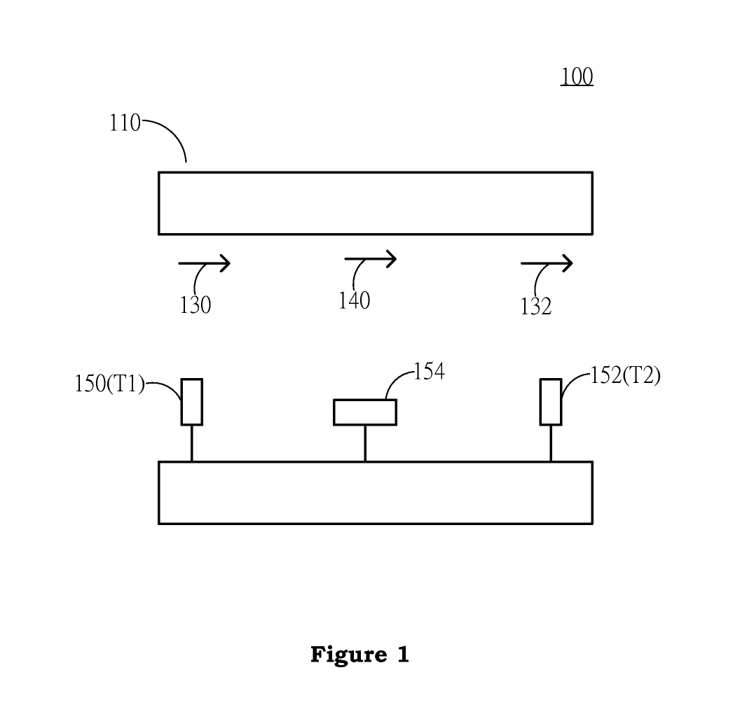

FIG. 2 illustrates the cross-sectional view of the flow control device according to the present invention;

FIG. 3 illustrates the side view for the first end of the flow control device;

FIG. 4 illustrates the side view for the second end of the flow control device; and

FIG. 5 illustrates the flow diagram for the control method of fluid.

### DESCRIPTION OF THE PREFERRED EMBODIMENT

Regarding the abovementioned and other technical content, feature and function of the present invention, they will be clearly described in the following preferred embodiment.

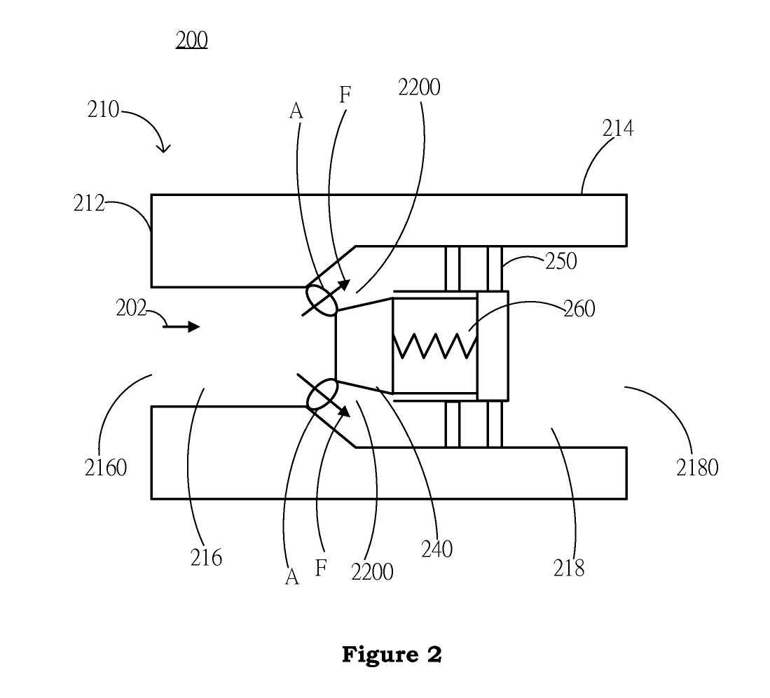

FIG. 2 illustrates the cross-sectional view of the flow control device 200 according to the present invention. The flow control device 200 is suitable for a fluid 202, in which the fluid 202 includes the gas or the liquid. In the embodiment, the fluid 202 is a gas. The flow control device 200 comprises the body 210, the plug 240, the laminar flow layer 250 and the telescopic device 260.

In the embodiment, the body 210 is a cylinder. It is noted that the body 210 of the present invention can be any shape, such as rectangle, trapezoid, rhombus, triangular and ellipse cylinder. The body 210 includes a first end 212 and an opposite second end 214. The first end 212 is the inlet of the fluid (i.e. gas inlet end). The second end 214 is the outlet of the fluid (i.e. gas inlet end). The body 210 includes a first flow channel 216 and a second flow channel 218. The first flow channel 216 connects with the second flow channel 218. The first flow channel 216 is punching the first end 212 to form the first opening 2160. The second flow channel 218 is punching the second end 214 to form the second opening 2180. The first flow channel 216 connects with the second flow channel 218 via the third opening 2200.

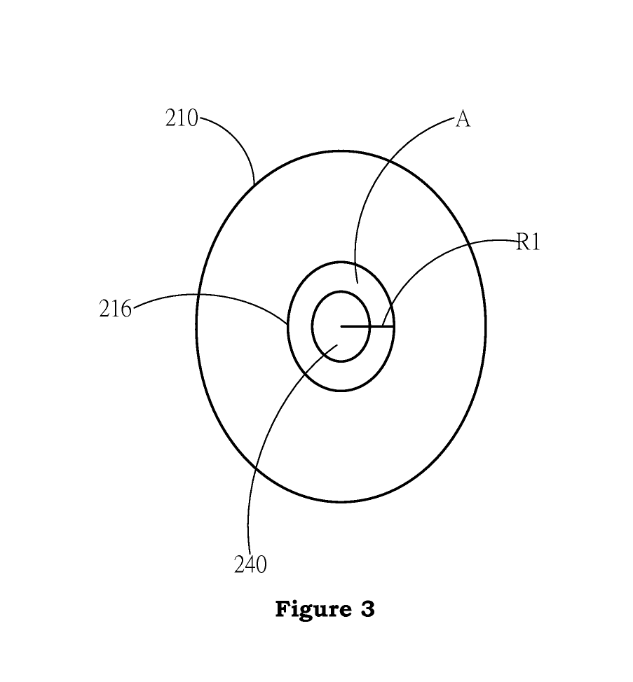

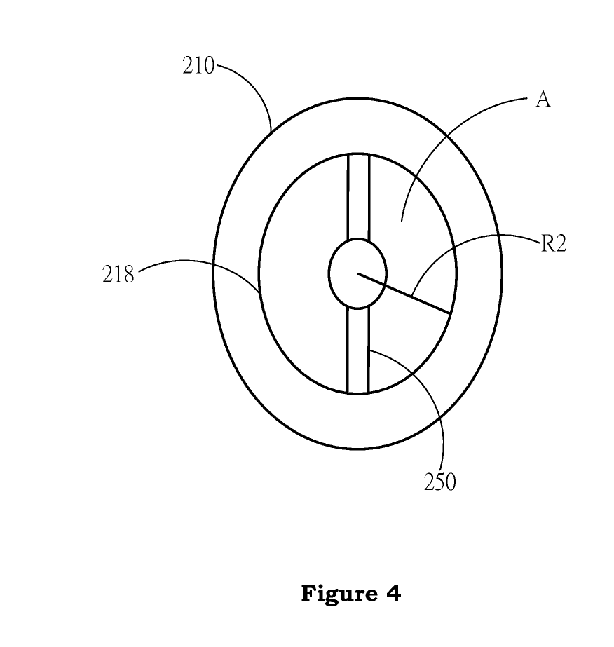

Please refer to FIG. 3 and FIG. 4. FIG. 3 illustrates the side view for the first end 212 of the flow control device 200, wherein the first flow channel 216 has a first pipe diameter R1. FIG. 4 illustrates the side view for the second end 214 of the flow control device 200, wherein the second flow channel 218 has a second pipe diameter R2, and the second pipe diameter R2 is greater than the first pipe diameter R1. In FIG. 3, the cross-sectional shape of the first flow channel 216 is a circle. In FIG. 4, the cross-sectional shape of the second flow channel 218 is a circle. It is noted that the cross-sectional shape of the first flow channel 216 shown in FIG. 3 may be any shape, including rectangle, trapezoid, rhombus, triangular or ellipse. The cross-sectional shape of the second flow channel 218 shown in FIG. 4 may be any shape, including rectangle, trapezoid, rhombus, triangular or ellipse.

In FIG. 3, the plug 240 is accommodated in the second flow channel 218. In the embodiment, the cross-sectional shape of the plug 240 is a circle. It is noted that the cross-sectional shape of the plug 240 may be rectangle, trapezoid, rhombus, triangular and or ellipse to match the shape of the flow channel. The material of the plug 240 is the elastic material, such as rubber, or the rigid material, such as stainless material.

In FIG. 4, the laminar flow layer 250 is accommodated in the second flow channel 218 and fixing on the inside wall of the second flow channel 218. The fluid 202 shown in FIG. 2 flows through the laminar flow layer 250 to form a laminar flow state, which flows in the second flow channel 218 shown in FIG. 4 to get more precise measurement.

In FIG. 2, the telescopic device 260 is accommodated in the body 210 and connecting the laminar flow layer 250 and the plug 240. The telescopic device 260 parallels to the first flow channel 216 or the second flow channel 218 to adjust its length. In the embodiment, the telescopic device 260 is spring. It is noted that the telescopic device 260 of the present invention is solenoid valve, pneumatic valve or hydraulic valve. The flow control device 200 controls the relative action of plug 240 in the first flow channel 216 or the second flow channel 218 via controlling the length of the telescopic device 260.

In FIG. 2, the flow control device 200 controls the length of the telescopic device 260, to control the relative action of plug 240 in the body 210, in order to adjust the relative position of the plug 240 and the third opening 2200, so as to control the opening area A of the third opening 2200. By controlling the flow F of the fluid 202 flows through the opening area A, it is able to control the flow F of the fluid 202 flows from the first flow channel 216 to the second flow channel 218.

In an embodiment shown in FIG. 2, when the flow channel is designed to measure small flow (such as milliliter grade), the flow control device 200 controls the stretch of the telescopic device 260 and control the plug 240 in the second flow channel 218 moving from the second end 214 toward the first end 212. At this time, the relative position between the plug 240 and the third opening 2200 is closer and closer. The plug 240 will shield more opening area A of the third opening 2200, in order to control the opening area A of the third opening 2200, so as to reduce the flow F of the fluid 202 in the body 210 flows through the opening area A. Via the abovementioned mechanism, the flow control device 200 can control the flow of the fluid 202 flows from the first flow channel 216 to the second flow channel 218.

In another embodiment shown in FIG. 2, when the flow channel is designed to measure large flow (such as over 2 liters), the flow control device 200 controls the contraction of the telescopic device 260, and controls the plug 240 in the second flow channel 218 moving from the first end 212 toward the second end 214. At this time, the relative position between the plug 240 and the third opening 2200 is longer. The plug 240 will shield less opening area A of the third opening 2200, in order to control the opening area A of the third opening 2200, so as to increase the flow F of the fluid 202 in the body 210 flows through the opening area A. Via the abovementioned mechanism, the flow control device 200 can control the flow of the fluid 202 flows from the first flow channel 216 to the second flow channel 218.

Please refer to FIG. 2. The flow control method of the present invention is suitable for the flow control device 200. This flow control device 200 is suitable for a fluid 202, in which the fluid 202 includes the gas or the liquid. In the embodiment, the body 210 is a cylinder. It is noted that the body 210 of the present invention can be any shape, such as rectangle, trapezoid, rhombus, triangular and ellipse cylinder. The body 210 includes a first end 212 and an opposite second end 214. The first end 212 is the inlet of the fluid (i.e. gas inlet end). The second end 214 is the outlet of the fluid (i.e. gas inlet end). The body 210 includes a first flow channel 216 and a second flow channel 218. The first flow channel 216 connects with the second flow channel 218. The first flow channel 216 is punching the first end 212 to form the first opening 2160. The second flow channel 218 is punching the second end 214 to form the second opening 2180. The first flow channel 216 connects with the second flow channel 218 via the third opening 2200.

Please refer to FIG. 3 and FIG. 4. FIG. 3 illustrates the side view for the first end 212 of the flow control device 200, in which the first flow channel 216 has a first pipe diameter R1. FIG. 4 illustrates the side view for the second end 214 of the flow control device 200, in which the second flow channel 218 has a second pipe diameter R2, and the second pipe diameter R2 is greater than the first pipe diameter R1 (shown in FIG. 3). The cross-sectional shape of the first flow channel 216 is a circle (shown in FIG. 3). The cross-sectional shape of the second flow channel 218 is a circle (shown in FIG. 4). It is noted that the cross-sectional shape of the first flow channel 216 shown in FIG. 3 may be any shape, including rectangle, trapezoid, rhombus, triangular or ellipse. The cross-sectional shape of the second flow channel 218 shown in FIG. 4 may be any shape, including rectangle, trapezoid, rhombus, triangular or ellipse.

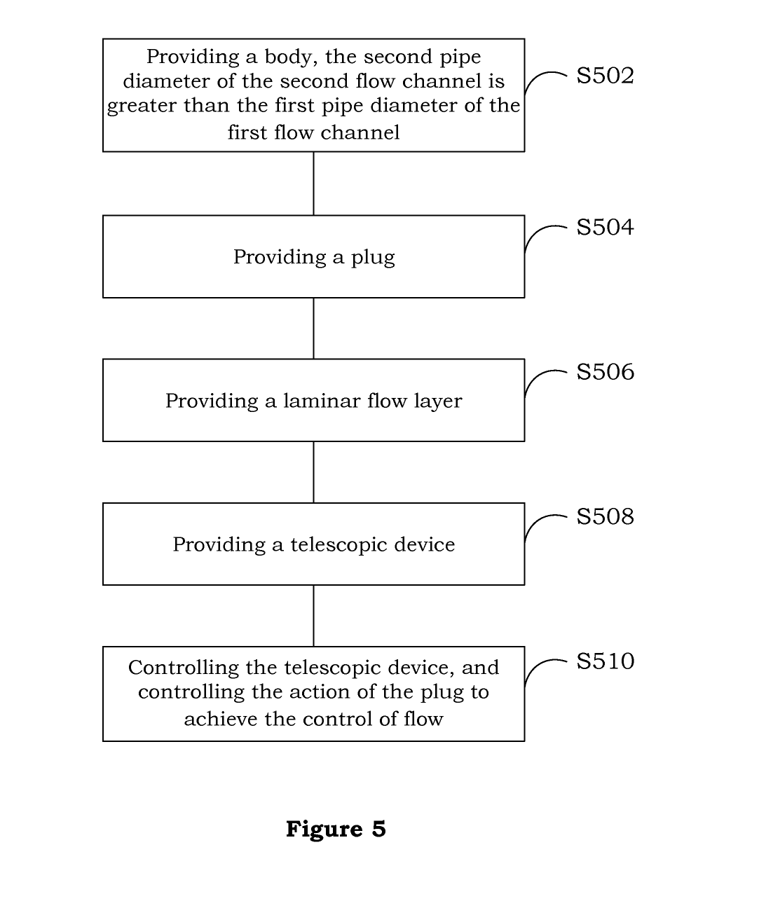

FIG. 5 illustrates the flow diagram for the control method of fluid. A body 210 is provided by Step S502 first. A plug 240 is provided by Step S504. The plug 240 is accommodated in the second flow channel 218. In the embodiment, the cross-sectional shape of the plug 240 is a circle. It is noted that the cross-sectional shape of the plug 240 may be rectangle, trapezoid, rhombus, triangular and or ellipse to match the shape of the flow channel. The material of the plug 240 is the elastic material, such as rubber, or the rigid material, such as stainless material.

In FIG. 5, a laminar flow layer 250 is provided by Step S506. The laminar flow layer 250 is accommodated in the second flow channel 218 and fixing on the inside wall of the second flow channel 218. The fluid 202 flows through the laminar flow layer 250 to form a laminar flow state, which flows in the second flow channel 218 obtain get more precise measurement.

In FIG. 5, a telescopic device 260 is provided by Step 5508. The telescopic device 260 is accommodated in the body 210 and connected the laminar flow layer 250 and the plug 240. The telescopic device 260 parallels to the first flow channel 216 or the second flow channel 218 to adjust its length. In the embodiment, the telescopic device 260 is spring. It is noted that the telescopic device 260 of the present invention is solenoid valve, pneumatic valve or hydraulic valve. The flow control device 200 controls the relative action of plug 240 in the first flow channel 216 or the second flow channel 218 via controlling the length of the telescopic device 260.

In Step 5510 of FIG. 5, the flow control device 200 controls the length of the telescopic device 260, to control the relative action of plug 240 in the body 210, in order to adjust the relative position of the plug 240 and the third opening 2200, so as to control the opening area A of the third opening 2200. By controlling the flow F of the fluid 202 flows through the opening area A, it is able to control the flow F of the fluid 202 flows from the first flow channel 216 to the second flow channel 218.

In an embodiment shown in FIG. 2, when the flow channel is designed to measure small flow (such as milliliter grade), the flow control device 200 controls the stretch of the telescopic device 260 and control the plug 240 in the second flow channel 218 moving from the second end 214 toward the first end 212. At this time, the relative position between the plug 240 and the third opening 2200 is closer and closer. The plug 240 will shield more opening area A of the third opening 2200, in order to control the opening area A of the third opening 2200, so as to reduce the flow F of the fluid 202 in the body 210 flows through the opening area A. Via the abovementioned mechanism, the flow control device 200 can control the flow of the fluid 202 flows from the first flow channel 216 to the second flow channel 218.

In another embodiment shown in FIG. 2, when the flow channel is designed to measure large flow (such as over 2 liters), the flow control device 200 controls the contraction of the telescopic device 260, and controls the plug 240 in the second flow channel 218 moving from the first end 212 toward the second end 214. At this time, the relative position between the plug 240 and the third opening 2200 is longer. The plug 240 will shield less opening area A of the third opening 2200, in order to control the opening area A of the third opening 2200, so as to increase the flow F of the fluid 202 in the body 210 flows through the opening area A. Via the abovementioned mechanism, the flow control device 200 can control the flow of the fluid 202 flows from the first flow channel 216 to the second flow channel 218.

Through the abovementioned flow control device and method for controlling the flow and the combination of different flow channel, control the telescopic device to drive the plug 240, in order to suitably adjust large flow and small flow of fluid in wide range of flow without changing the flow channel. It can simplify the materials prepared for the device instead of preparing a lot of flow control devices for different flow.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A flow control device, comprising:
a body including a first end, opposite second end, the body having a first flow channel and a second flow channel, the first flow channel with a first pipe diameter, the second flow channel with a second pipe diameter, the second pipe diameter is greater than the first pipe diameter, the first flow channel punching through a first end to form a first opening, the second flow channel punching through a second end to form a second opening, the first flow channel connecting with the second flow channel via a third opening;
a plug accommodated in the second flow channel;
a laminar flow layer accommodated in the second flow channel and fixed on an inside wall of the second flow channel; and
a telescopic device accommodated in the body and connecting between the laminar flow layer and the plug, a length of the telescopic device is adjustable;
wherein the telescopic device being used to control a relative motion of the plug in the body, to adjust the relative position of the plug and the third opening, in order to control the opening area of the third opening, so that control a flow of a fluid flowing through the opening area in the body.

2. The method according to claim 1, wherein the second flow channel is greater than the first flow channel, the telescopic device being used to control the relative motion of the plug in the body, to adjust the relative position of the plug and the third opening, in order to control the opening area of the third opening, so that control the flow of fluid flowing through the opening area in the body.

3. The device according to claim 1, wherein the fluid is selected from the group consisting of gas and liquid.

4. The device according to claim 1, wherein the cross-sectional of the first flow channel is a circle.

5. The device according to claim 1, wherein the cross-sectional shape of the first flow channel is selected from the group consisting of the trapezoid, rhombus, triangle and ellipse.

6. The device according to claim 1, wherein the cross-sectional shape of the second flow channel is a circle.

7. The device according to claim 1, wherein the cross-sectional shape of the second flow channel is selected from the group consisting of the trapezoid, rhombus, triangle and ellipse.

8. The device according to claim 1, wherein the cross-sectional shape of the plug is selected from the group consisting of circle, trapezoid, rhombus, triangle and ellipse.

9. The device according to claim 1, wherein the material of the plug is selected from the group consisting of rubber stainless steel.

10. The device according to claim 1, wherein the telescopic device is selected from the group consisting of solenoid valve, pneumatic valve, spring or hydraulic valve.

11. A flow control method for a flow control device, comprising:
providing a body including a first end, opposite second end, the body having a first flow channel and a second flow channel, the first flow channel with a first pipe diameter, the second flow channel with a second pipe diameter, the second pipe diameter is greater than the first pipe diameter, the first flow channel punching through the first end to form a first opening, the second flow channel punching through the second end to form a second opening, the first flow channel connecting with the second flow channel via a third opening;
providing a plug accommodated in the second flow channel;
providing a laminar flow layer accommodated in the second flow channel and fixed on an inside wall of the second flow channel; and
providing a telescopic device accommodated in the body and connecting between the laminar flow layer and the plug, a length of the telescopic device is adjustable;
wherein the telescopic device is used to control the relative motion of the plug in the body, to adjust the relative position of the plug and the third opening, in order to control the opening area of the third opening, so that control a flow of a fluid flowing through the opening area in the body.

12. The method according to claim 10, wherein the cross-sectional shape of the first flow channel is selected from the group consisting of the circle, trapezoid, rhombus, triangle and ellipse.

13. The method according to claim 11, wherein the cross-sectional shape of the second flow channel is selected from the group consisting of the circle, trapezoid, rhombus, triangle and ellipse.

14. The method according to claim 11, wherein the cross-sectional shape of the plug is selected from the group consisting of a circle, trapezoid, rhombus, triangle and ellipse.

15. The method according to claim 11, wherein the material of the plug is selected from the group consisting of rubber and stainless steel.

16. The method according to claim 11, wherein the telescopic device is selected from the group consisting of solenoid valve, pneumatic valve, spring or hydraulic valve.
